(19) United States
(12) Patent Application Publication
(10) Pub. No.: US 2024/0008540 A1
(43) Pub. Date: Jan. 11, 2024

(54) HEATER FOR USE IN AEROSOL GENERATION DEVICE, AND AEROSOL GENERATION DEVICE

(71) Applicant: SHENZHEN FIRST UNION TECHNOLOGY CO., LTD., Shenzhen, Guangdong Province (CN)

(72) Inventors: Jian WU, Shenzhen, Guangdong Province (CN); Zhongli XU, Shenzhen, Guangdong Province (CN); Yonghai LI, Shenzhen, Guangdong Province (CN)

(73) Assignee: SHENZHEN FIRST UNION TECHNOLOGY CO., LTD., Shenzhen, Guangdong Province (CN)

(21) Appl. No.: 18/257,295

(22) PCT Filed: Dec. 15, 2021
(86) PCT No.: PCT/CN2021/138402

§ 371 Date: Jun. 14, 2023

(30) Foreign Application Priority Data
Dec. 17, 2020 (CN) 202011494736.0

(51) Int. Cl. A24F 40/46; H05B 3/46; A24F 40/20; A24F 40/51

(52) U.S. Cl. CPC A24F 40/46; H05B 3/46; A24F 40/20; A24F 40/51; H05B 2203/016

(57) ABSTRACT

A vapor generation device includes: a heater, configured to heat a received aerosol-forming article; and the heater includes: a shell, constructed to at least partially extend in an axial direction of a cavity and have a hollow extending in the axial direction; and a heating coil, located in the hollow of the shell and constructed to extend in an axial direction of the shell, where a wire material of the heating coil has a cross section including a primary part, and an extension length of the primary part in an axial direction of the heating coil is greater than an extension length of the primary part in a radial direction of the heating coil. In the vapor generation device constructed above, the wire material of the heating coil in the heater is completely or at least partially flattened in form, which can reduce energy loss in a resistive heating coil.

### CROSS-REFERENCE TO RELATED APPLICATIONS

This application claims priority to Chinese Patent Application No. 202011494736.0, filed with China National Intellectual Property Administration on Dec. 17, 2020 and entitled “HEATER FOR VAPOR GENERATION DEVICE AND VAPOR GENERATION DEVICE”, which is incorporated herein by reference in its entirety.

### TECHNICAL FIELD

Embodiments of this application relate to the field of heat not burning cigarette device technologies, and in particular, to a heater for a vapor generation device and a vapor generation device.

### BACKGROUND

Tobacco products (for example, cigarettes and cigars) burn tobacco during use to produce tobacco smoke. Attempts are made to replace these tobacco-burning products by manufacturing products that release compounds without burning.

An example of the products is a heating device that releases a compound by heating rather than burning a material. For example, the material may be tobacco or other non-tobacco products, where the non-tobacco products may or may not include nicotine. Known in the art, the patent No. 202010054217.6 proposes to heat tobacco products to generate an aerosol with a heater in which a spiral heating wire is encapsulated in an outer sleeve.

### SUMMARY

An embodiment of this application provides a vapor generation device, configured to heat a vapor-forming article to generate an aerosol for inhalation, including:
a cavity, configured to receive the vapor-forming article;
a heater, constructed to at least partially extend in the cavity, to heat an aerosol-forming article received in the cavity, where the heater includes:
a shell, constructed to at least partially extend in an axial direction of the cavity and have a hollow extending in the axial direction; and
a heating coil, located in the hollow of the shell and constructed to extend in the axial direction of the shell, where a wire material of the heating coil has a cross section including a primary part, and an extension length of the primary part in an axial direction of the heating coil is greater than an extension length of the primary part in a radial direction of the heating coil.

In the vapor generation device constructed above, by comparing the heating coil in the heater with a conventional spiral heating coil that is formed by a wire with a circular cross section, the wire material is completely or at least partially flattened in form. Therefore, the wire material extends to a relatively small extent in the radial direction, and energy loss in the resistive heating coil may be reduced through this measure, and in particular, heat transfer may be promoted.

In a preferred implementation, the primary part forms an entire cross section of the wire material.

In a preferred implementation, the primary part has a rectangular shape.

In a preferred implementation, the heating coil includes 6 to 20 windings or turns.

In a preferred implementation, an extension length of the primary part in an axial direction of the heating coil ranges from 1 to 4 mm;

and/or the extension length of the primary part in the radial direction of the heating coil ranges from 0.1 to 1 mm.

In a preferred implementation, the heater further includes a conductive pin for supplying power to the heating coil, and the conductive pin includes:
a first conductive pin, connected to a first end of the heating coil; and
a second conductive pin, connected to a second end of the heating coil and penetrating the heating coil from the second end to the first end.

In a preferred implementation, the wire material of the heating coil has a positive or negative resistance-temperature coefficient, to enable a temperature of the heating coil to be determined by detecting a resistance of the heating coil.

In a preferred implementation, the first conductive pin and the second conductive pin are made of different materials, to cause a thermocouple for sensing a temperature of the heating coil to be formed between the first conductive pin and the second conductive pin.

In a preferred implementation, the heater further includes a base, and the vapor generation device holds the heater through the base.

In a preferred implementation, the cross section of the wire material further includes a secondary part, and an extension length of the secondary part in the radial direction of the heating coil is greater than an extension length of the secondary part in the axial direction of the heating coil.

In a preferred implementation, the secondary part is closer to a central axis of the heating coil than the primary part.

In a preferred implementation, in the axial direction, the heating coil includes a first part close to a first end, a second part close to a second end, and a third part located between the first part and the second part, where in the axial direction of the heating coil, a number of windings or turns per unit length in the third part is less than a number of windings or turns per unit length in one or both of the first part and the second part.

In a preferred implementation, the heating coil includes a first part and a second part arranged in an axial direction, where in the axial direction of the heating coil, a number of windings or turns per unit length in the first part is less than a number of windings or turns per unit length in the second part.

In a preferred implementation, a number of windings or turns per unit length of the heating coil in the axial direction is gradually changed.

Another embodiment of this application further provides a vapor generation device, configured to heat a vapor-forming article to generate an aerosol for inhalation, including:
a cavity, configured to receive the vapor-forming article;
a heater, constructed to at least partially extend in the cavity, to heat an aerosol-forming article received in the cavity, where the heater includes:
a shell, constructed to at least partially extend in an axial direction of the cavity, and have a hollow extending in the axial direction; and
a heating coil, located in the hollow of the shell, where the heating coil includes a first part and a second part arranged in an axial direction, and in the axial direction of the heating coil, a number of windings or turns per unit length in the first part is less than a number of windings or turns per unit length in the second part.

Another embodiment of this application further provides a heater for a vapor generation device, where the heater includes:
a shell, constructed to be in a pin or needle shape, where the shell has a hollow extending in an axial direction; and
a heating coil, located in the hollow of the shell and constructed to extend in the axial direction of the shell, where a wire material of the heating coil has a cross section including a primary part, and an extension length of the primary part in an axial direction of the heating coil is greater than an extension length of the primary part in a radial direction of the heating coil.

Another embodiment of this application further provides a heater for a vapor generation device, where the heater includes:
a shell, constructed to be in a pin or needle shape, where the shell has a hollow extending in an axial direction; and
a heating coil, located in the hollow of the shell, where the heating coil includes a first part and a second part arranged in an axial direction, and in the axial direction of the heating coil, a number of windings or turns per unit length in the first part is less than a number of windings or turns per unit length in the second part.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic structural diagram of a vapor generation device according to an embodiment of this application;

FIG. 2 is a schematic exploded view of a heater in FIG. 1 according to an embodiment;

FIG. 3 is a schematic cross sectional view of a viewing angle of a resistive heating coil in FIG. 2;

FIG. 4 is a schematic cross sectional view of a resistive heating coil according to another embodiment;

FIG. 5 is a schematic cross sectional view of a resistive heating coil according to another embodiment;

FIG. 6 is a schematic cross sectional view of a resistive heating coil according to another embodiment;

FIG. 7 is a schematic diagram of a resistive heating coil according to another embodiment;

FIG. 8 is a schematic diagram of a heating curve for controlling a heater to heat an aerosol-forming article at a predetermined time according to an implementation;

FIG. 9 is a result of comparison of a TPM value of an aerosol-forming article heated by a heater of a test embodiment with that for a heater of a comparative example according to an implementation;

FIG. 10 is a result of comparison of a TPM value of an aerosol-forming article heated by a heater of a test embodiment with that for a heater of a comparative example according to another implementation;

FIG. 11 is a result of comparison of a TPM value of an aerosol-forming article heated by a heater of a test embodiment with that for a heater of a comparative example according to another implementation; and

FIG. 12 is a result of comparison of a TPM value of an aerosol-forming article heated by a heater of a test embodiment with that for a heater of a comparative example according to another implementation.

### DETAILED DESCRIPTION

For ease of understanding of this application, this application is described below in more detail with reference to accompanying drawings and specific implementations.

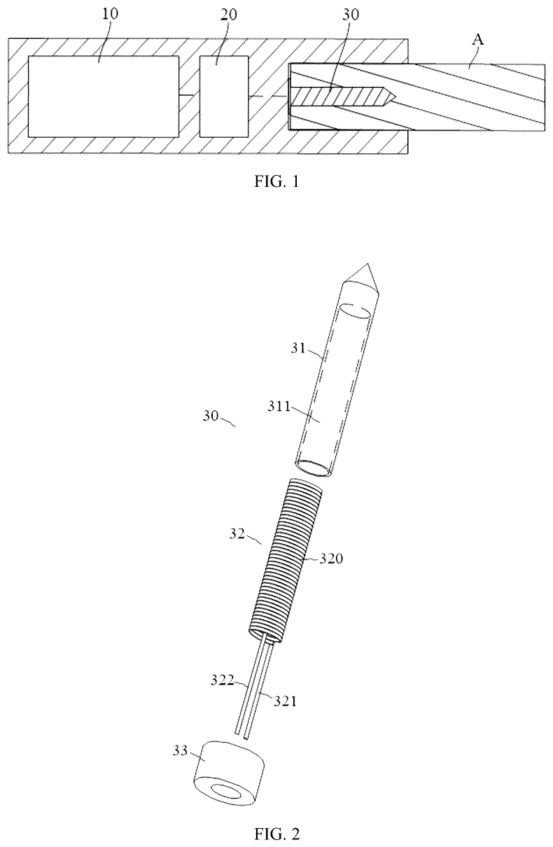

An embodiment of this application provides a vapor generation device whose construction may refer to FIG. 1, including:
a cavity, where an aerosol-forming article A is received detachably in the cavity;
a heater 30 at least partially extending in the cavity and inserted into the aerosol-forming article A for heating when the aerosol-forming article A is received in the cavity, so that the aerosol-forming article A releases a plurality of volatile compounds, and the volatile compounds are formed only by heating;
a battery cell 10, configured to supply power; and
a circuit 20, configured to guide a current between the battery cell 10 and the heater 30.

In a preferred embodiment, the heater 30 is substantially in a pin or needle shape, which is advantageous for inserting into the aerosol-forming article A. In addition, the heater 30 may have a length of approximately 12 to 19 millimeters, and an outer diameter of approximately 2 to 4 millimeters.

Further, in an optional implementation, the aerosol-forming article A is preferably made of a tobacco-containing material that releases a volatile compound from a substrate when being heated, or a non-tobacco material suitable for electric heating and smoking after being heated. The aerosol-forming article A is preferably made of a solid substrate. The solid substrate may include one or more of powders, particles, fragmented strips, strips, or flakes of one or more of vanilla leaves, tobacco leaves, homogeneous tobacco, and expanded tobacco. Alternatively, the solid substrate may include additional tobacco or non-tobacco volatile aroma compounds to be released when the substrate is heated.

FIG. 2 is a schematic exploded view of parts of a heater 30 according to an embodiment before being assembled, including:
a shell 31, constructed to be in a pin or needle shape of a hollow 311 and have a conical tip at a front end for being easily inserted into the aerosol-forming article A and an opening at a rear end for easily assembling functional components in the shell; and
a heating member 32, configured to generate heat, and specifically structurally including a resistive heating coil 320 in a spiral shape constructed to extend along a part of the shell 31 in an axial direction, a first conductive pin 321 connected to a lower end of the resistive heating coil 320, and a second conductive pin 322 connected to an upper end of the resistive heating coil 320. During use, the first conductive pin 321 and the second conductive pin 322 are configured to supply power to the resistive heating coil 320.

In an implementation shown in FIG. 2, the resistive heating coil 320 is fully assembled and maintained in the hollow 311 of the shell 31, and the resistive heating coil 320 and the shell 31 conduct heat to each other after assembly.

Further, in a preferred implementation shown in FIG. 2, the heater 30 further includes a base or flange 33. In the figure, the base or flange 33 is made of a heat resistant material such as ceramic or PEEK, and is preferably annular in shape. In assembly, a lower end of the shell 31 is fixed on the base or flange 33 through a high-temperature adhesive or molding such as in-mold injection molding, and then the vapor generation device may fix the base or flange 33 by supporting, clamping, or holding, thereby stably mounting and holding the heater 30. Certainly, after the base or flange 33 is assembled to the lower end of the shell 31, the first conductive pin 321 and the second conductive pin 322 penetrate a middle hole of the base or flange 33, to be conveniently connected to the circuit 20.

In an optional implementation, the resistive heating coil 320 is made of a metal material with an appropriate impedance, a metal alloy, graphite, carbon, conductive ceramic, or another composite material of a ceramic material and a metal material. A suitable metal or alloy material includes at least one of nickel, cobalt, zirconium, titanium, nickel alloy, cobalt alloy, zirconium alloy, titanium alloy, nickel-chromium alloy, nickel-iron alloy, iron-chromium alloy, iron-chromium-aluminum alloy, titanium alloy, iron-manganese-aluminum based alloy, or stainless steel.

The shell 31 is made of a heat-resistant and heat-conductive material such as glass, ceramic, metal, or alloy, for example, stainless steel. Certainly, after assembly, the resistive heating coil 320 and an inner wall of the hollow 311 of the shell 31 abut against each other to conduct heat to each other, and are insulated from each other when the shell 31 is made of metal or alloy. For example, insulation may be formed between contact surfaces of the resistive heating coil 320 and the inner wall of the hollow 311 of the shell 31 by gluing, surface oxidation, or spraying an insulation layer.

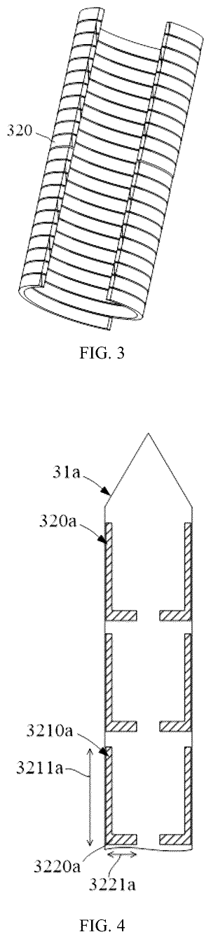

FIG. 3 is a schematic cross sectional view of a viewing angle of a resistive heating coil 320 in FIG. 2. A cross section of the wire material of the resistive heating coil 320 is in a wide or flat shape that is different from a conventional circular shape. In a preferred implementation shown in FIG. 3, the cross section of the wire material of the resistive heating coil 320 has a size extending in a longitudinal direction that is greater than a size extending in a radial direction perpendicular to a part extending in the longitudinal direction, so that the resistive heating coil 320 has a flat rectangular shape.

Simply, by comparing the resistive heating coil 320 constructed above with a conventional spiral heating coil that is formed by a wire with a circular cross section, the wire material is completely or at least partially flattened in form. Therefore, the wire material extends to a relatively small extent in the radial direction. In this way, energy loss in the resistive heating coil 320 may be reduced. Particularly, heat transfer may be promoted.

Preferably, the cross section of the resistive heating coil 320 has a rectangular shape to form an entire cross section of the resistive heating coil 320. In the embodiments, the resistive heating coil 320 is spirally formed by a wire material with a rectangular cross section, to form a flat coil in a spiral shape that is easy to manufacture. After the energy loss is reduced, the resistive heating coil is provided with an additional advantage of minimizing an outer diameter, which is beneficial for an allowed range of the outer diameter of a prepared heating member 32.

Further, FIG. 4 is a schematic diagram of a heater 30 according to another embodiment. A resistive heating coil 320a is encapsulated in a shell 31a in a pin or needle shape. Specifically,

a cross section of a wire material of the resistive heating coil 320a is L-shaped, and includes a primary part 3210a and a secondary part 3220a.

An extension length of the primary part 3210a in an axial direction of the resistive heating coil 320a is greater than an extension length of the primary part in the radial direction of the resistive heating coil; and an extension length of the secondary part 3220a in the axial direction of the resistive heating coil 320a is less than an extension length of the secondary part in the radial direction of the resistive heating coil. Finally, in the overall shape, an extension length 3211a of a cross section profile of the wire material of the resistive heating coil 320a in the axial direction is greater than an extension length 3221a of the cross section profile in the radial direction. During use, the primary part 3210a is closer to the shell 31a, so that the primary part 3210a and the shell 31a conduct heat to each other after assembly, and the secondary part 3220a extends radially inward.

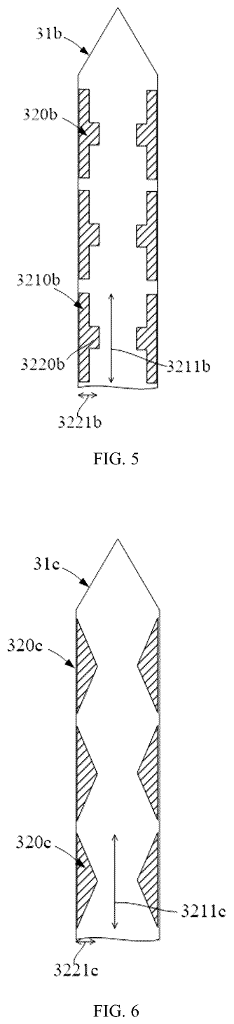

Alternatively, in another variation implementation shown in FIG. 5, a cross section of a wire material of a resistive heating coil 320b is in a shape of T including a primary part 3210b and a secondary part 3220b. In this case, T is arranged in an inverted manner, and the ‘head’ of T forms the primary part 3210b and is arranged parallel to a longitudinal axis of the resistive heating coil 320b. Similarly, an extension length 3211b of a cross section profile in an axial direction is greater than an extension length 3221b of the cross section profile in a radial direction.

The extension length of the secondary parts 3220a/3220b in the radial direction of the resistive heating coil 320b is always greater than the extension length of the primary part 3210a in the radial direction.

FIG. 6 shows a shape of a resistive heating coil 320c according to another embodiment. A cross section of a wire material of the resistive heating coil is in a shape of a triangle, so that an extension length 3211c of a cross section profile in an axial direction is greater than an extension length 3221c of the cross section profile in a radial direction. In addition, the bottom of the triangle is arranged parallel to a longitudinal axis of the resistive heating coil 320b.

Further, according to the foregoing preferred implementations, the resistive heating coils 320/320a/320b/320c have 6 to 20 windings or turns. The foregoing resistive heating coils 320/320a/320b/320c are made of a uniformly sized wire material, so that the windings are substantially the same. If the wire material is provided with secondary parts 3220a/3220b in the radial direction, the secondary parts 3220a/3220b of individual windings are spaced apart from each other. Secondary parts 3220a/3220b are spaced apart from each other not only by a distance between adjacent windings such as in conventional resistive heating coils 320a/320b, but also by the extension length of the primary parts 3210a/3210b in the axial direction, which is advantageous for mounting and fixing the resistive heating coils 320a/320b/320c that have secondary parts 3220a/3220b or whose cross sections are triangular.

In a preferred implementation, the cross sections of the wire materials of the resistive heating coils 320/320a/320b/320c have extension lengths 3211a/3211b/3211c in the axial direction approximately ranging from 1 to 4 mm, and extension lengths 3221a/3221b/3221c in the radial direction approximately ranging from 0.1 to 1 mm.

Further, in a preferred implementation shown in FIG. 2, the second conductive pin 322 is welded to the upper end of the resistive heating coil 320 and then penetrates the hollow 311 of the resistive heating coil 320 to a lower position, to be conveniently connected or assembled to the circuit 20. To insulate the second conductive pin 322 from other parts of the resistive heating coil 320 after penetration, in a preferred implementation, the second conductive pin 322 is sleeved with a tube (not shown in the figure) made of an insulating material such as PEEK or PI.

In an optional implementation, the first conductive pin 321 and the second conductive pin 322 are made of a material with a low resistance-temperature coefficient. In addition, the resistive heating coil 320 is made of a material with a relatively large positive or negative resistance-temperature coefficient, so that the circuit 20 may obtain a temperature of the resistive heating coil 320 by detecting the resistance-temperature coefficient of the resistive heating coil 320 during use.

In another preferred implementation, the first conductive pin 321 and the second conductive pin 322 are made of two different materials of thermocouple materials such as nickel, nickel-chromium alloy, nickel-silicon alloy, nickel-chromium-copper, constantan, and iron-chromium alloy. Then, a thermocouple for detecting the temperature of the resistive heating coil 320 is formed between the first conductive pin 321 and the second conductive pin 322, to obtain the temperature of the resistive heating coil 320.

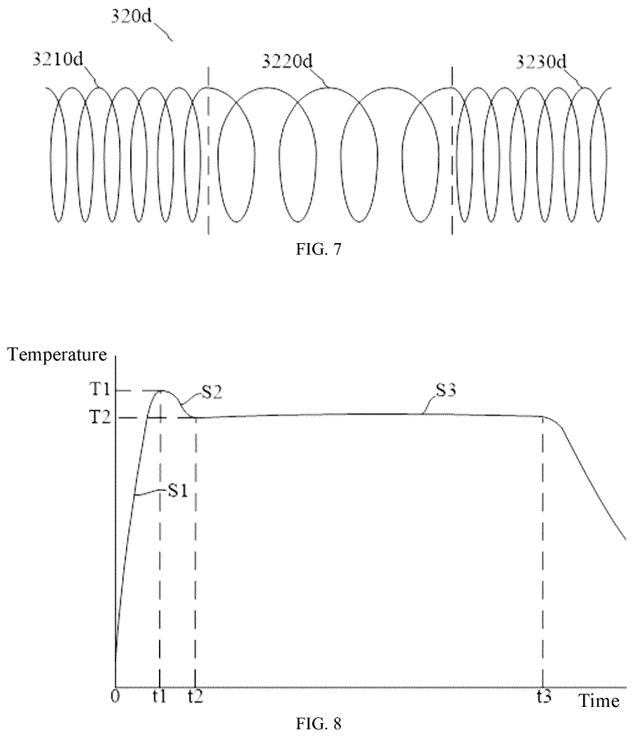

Further, refer to FIG. 7, which is a schematic diagram of a resistive heating coil 320d according to another embodiment. The resistive heating coil 320d includes a first part 3210d closest to a first end, a second part 3230d arranged closest to a second end, and a third part 3220d arranged between the first part 3210d and the second part 3230d, and a number of windings or turns per unit length in the third part 3220d of the resistive heating coil is less than a number of windings or turns per unit length in one or both of the first part 3210d and the second part 3220d.

During implementation, compared with coils with the same number of turns or winding density, heat which can be mainly concentrated in the middle may be more easily conducted and diffused to both ends, so that finally a temperature of each part of the resistive heating coil 320d in the axial direction in operation is maintained substantially uniform or close.

In an optional implementation, a cross section of a wire material of the resistive heating coil 320d may be rectangular or L-shaped, or may be generally circular.

Alternatively, in another optional implementation, the resistive heating coil 320d may include another section having at least two different turn densities, or in a form in which a turn density gradually changes, so that a distribution of heat of the resistive heating coil 320d in operation may be further adjusted or changed.

To display an advantage of the heater 30 in heating the aerosol-forming article A, the heater 30 is used in one embodiment to heat the aerosol-forming article A according to a classical heating curve and monitor an amount of aerosol generated during heating, that is, a TPM value. The amount of aerosol is represented by the TPM (Total Particulate Matter) value commonly used in the art. In this implementation, a heating curve for heating an aerosol-forming article A is shown in FIG. 8, including:
a preheating stage S1: a temperature of the heater is rapidly increased from a room temperature to a first preset temperature T1 (about 365° C.) from a moment 0 to a moment t1 (for example, 20 s) to preheat the aerosol-forming article;
a cooling stage S2: the heater starts to cool from the first preset temperature T1 from the moment t1 until the temperature of the heater drops to a second preset temperature T2 (about 330° C.) at a moment t2 (for example, 35 s); and
an inhalation stage S3: the temperature of the heater is substantially maintained at the second preset temperature T2 (about 330° C.) until a moment t3 (for example, 4 min 15 s), and heating is stopped after inhalation is completed.

Further, a TPM value for each number of times of inhalation in heating the aerosol-forming article A is measured by using a heater of a conventional spiral coil with a circular cross section of the wire material (the number of turns and material are the same as those of the resistive heating coil 320 in this embodiment) as a comparison example. Specifically:

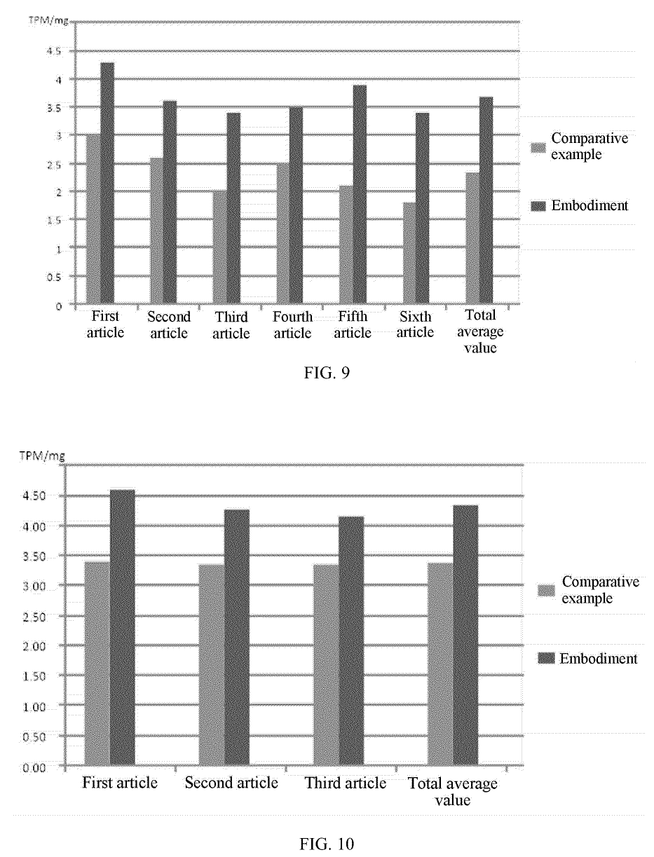

FIG. 9 is a result of comparison between TPM values generated during a first inhalation of six aerosol-forming articles A through an automatic inhalation device at about 25 s of the heating curve, as tested in one implementation. As shown in FIG. 9, a heater 30 provided in this embodiment heats each of the six aerosol-forming articles A to generate a higher TPM value during the first inhalation than that in the comparative example. In a test result shown in FIG. 9, an average value of TPM values generated by the six aerosol-forming articles A tested by the heater 30 provided in this embodiment during the first inhalation is 3.68 mg, and an average value of TPM values generated by the six aerosol-forming articles A tested in the comparative example during the first inhalation is only 2.4 mg.

FIG. 10 shows a result of comparison between average TPM values generated during nine times of inhalation for three aerosol-forming articles A obtained at the end of a cycle of a heating curve after the three aerosol-forming articles A are each inhaled for nine times at intervals of 25s through an automatic inhalation device tested in one implementation. As shown in FIG. 10, a plurality of times of intermittent inhalation involved in a full cycle of the heating curve, an average TPM value generated by three aerosol-forming articles A tested by a heater 30 provided in this embodiment during a plurality of times of inhalation is 4.33 mg, while an average TPM value generated by three aerosol-forming articles A tested in a comparative example during a plurality of times of inhalation is only 3.36 mg.

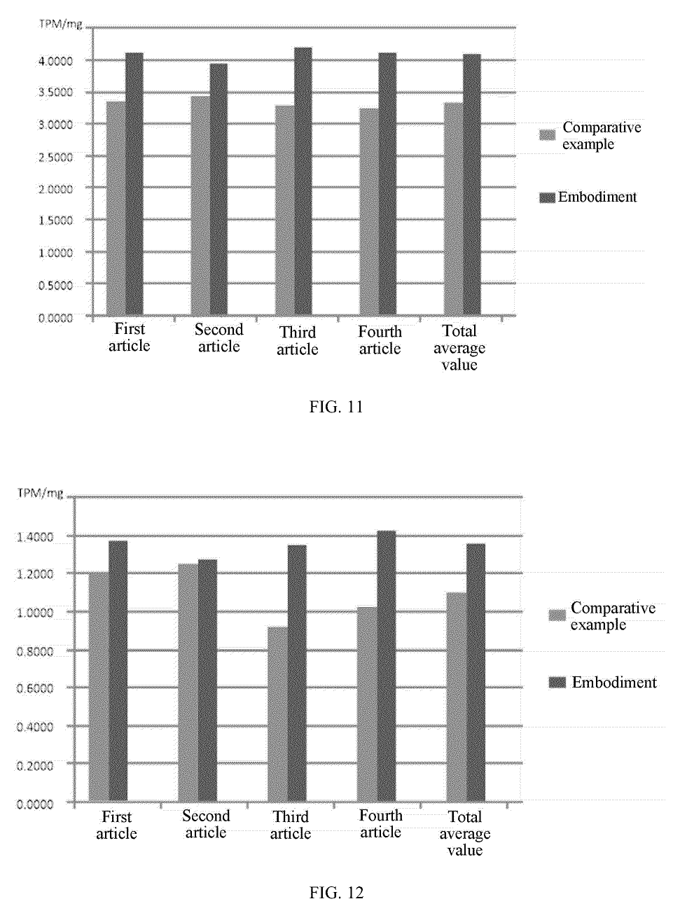

Further, in another implementation, four aerosol-forming articles A are inhaled 13 times at intervals of 20s through an automatic inhalation device during heating until a heating cycle ends. A result of comparison between average TPM values generated during the first nine times of inhalation in the heating cycle obtained by a test is shown in FIG. 11, and a result of comparison between average TPM values generated during the last four times of inhalation in the heating cycle obtained by the test is shown in FIG. 12. As shown in FIG. 11, a heater provided in this embodiment has an average TPM value of 4.09 mg generated during the first nine times of inhalation, and a heater provided in a comparative example has an average TPM value of only 3.33 mg generated during the first nine times of inhalation. As shown in FIG. 12, a heater provided in this embodiment has an average TPM value of 1.36 mg generated during the last four times of inhalation, and a heater provided in a comparative example has an average TPM value of 1.10 mg generated during the last four times of inhalation.

It should be noted that, the specification of this application and the accompanying drawings thereof illustrate preferred embodiments of this application, but this application is not limited to the embodiments described in the specification. Further, a person of ordinary skill in the art may make improvements or variations according to the foregoing descriptions, and such improvements and variations shall all fall within the protection scope of the appended claims of this application.

1. A vapor generation device, configured to heat a vapor-forming article to generate an aerosol for inhalation, comprising:
a cavity, configured to receive the vapor-forming article;
a heater, configured to heat an aerosol-forming article received in the cavity, wherein the heater comprises:
a shell, constructed to at least partially extend in an axial direction of the cavity and have a hollow extending in the axial direction; and
a heating coil, located in the hollow and constructed to extend in an axial direction of the shell, wherein a wire material of the heating coil has a cross section comprising a primary part, and an extension length of the primary part in an axial direction of the heating coil is greater than an extension length of the primary part in a radial direction of the heating coil.

2. The vapor generation device according to claim 1, wherein the primary part forms an entire cross section of the wire material.

3. The vapor generation device according to claim 1, wherein the primary part has a rectangular shape.

4. The vapor generation device according to claim 1, wherein the heating coil comprises 6 to 20 windings or turns.

5. The vapor generation device according to claim 1, wherein the extension length of the primary part in the axial direction of the heating coil ranges from 1 to 4 mm;
and/or the extension length of the primary part in the radial direction of the heating coil ranges from 0.1 to 1 mm.

6. The vapor generation device according to claim 1, wherein the heater further comprises a conductive pin for supplying power to the heating coil, and the conductive pin comprises:
a first conductive pin, connected to a first end of the heating coil; and
a second conductive pin, connected to a second end of the heating coil and penetrating the heating coil from the second end to the first end.

7. The vapor generation device according to claim 6, wherein the wire material of the heating coil has a positive or negative resistance-temperature coefficient, to enable a temperature of the heating coil to be determined by detecting a resistance of the heating coil.

8. The vapor generation device according to claim 6, wherein the first conductive pin and the second conductive pin are made of different materials, to cause a thermocouple for sensing a temperature of the heating coil to be formed between the first conductive pin and the second conductive pin.

9. The vapor generation device according to claim 1, wherein the heater further comprises a base, and the vapor generation device holds the heater through the base.

10. The vapor generation device according to claim 1, wherein the cross section of the wire material further comprises a secondary part, and an extension length of the secondary part in the radial direction of the heating coil is greater than an extension length of the secondary part in the axial direction of the heating coil.

11. The vapor generation device according to claim 10, wherein the secondary part is closer to a central axis of the heating coil than the primary part.

12. The vapor generation device according to claim 1, wherein in the axial direction, the heating coil comprises a first part close to a first end, a second part close to a second end, and a third part located between the first part and the second part; and in the axial direction of the heating coil, a number of windings or turns per unit length in the third part is less than a number of windings or turns per unit length in one or both of the first part and the second part.

13. The vapor generation device according to claim 1, wherein the heating coil comprises a first part and a second part arranged in the axial direction; and in the axial direction of the heating coil, a number of windings or turns per unit length in the first part is less than a number of windings or turns per unit length in the second part.

14. The vapor generation device according to claim 1, wherein a number of windings or turns per unit length of the heating coil in the axial direction is gradually changed.

15. A vapor generation device, configured to heat a vapor-forming article to generate an aerosol for inhalation, comprising:
a cavity, configured to receive the vapor-forming article;
a heater, configured to heat an aerosol-forming article received in the cavity, wherein the heater comprises:
a shell, constructed to at least partially extend in an axial direction of the cavity and have a hollow extending in the axial direction; and
a heating coil, located in the hollow, wherein the heating coil comprises a first part and a second part arranged in an axial direction, and in the axial direction of the heating coil, a number of windings or turns per unit length in the first part is less than a number of windings or turns per unit length in the second part.

16. A heater for a vapor generation device, wherein the heater comprises:
a shell, constructed to be in a pin or needle shape, wherein the shell has a hollow extending in an axial direction; and
a heating coil, located in the hollow of the shell and constructed to extend in the axial direction of the shell, wherein a wire material of the heating coil has a cross section comprising a primary part, and an extension length of the primary part in an axial direction of the heating coil is greater than an extension length of the primary part in a radial direction of the heating coil.

17. (canceled)

18. The vapor generation device according to claim 2, wherein the primary part has a rectangular shape.

19. The vapor generation device according to claim 2, wherein the heating coil comprises 6 to 20 windings or turns.

20. The vapor generation device according to claim 2, wherein the extension length of the primary part in the axial direction of the heating coil ranges from 1 to 4 mm;
and/or the extension length of the primary part in the radial direction of the heating coil ranges from 0.1 to 1 mm.

21. The vapor generation device according to claim 2, wherein the heater further comprises a conductive pin for supplying power to the heating coil, and the conductive pin comprises:
a first conductive pin, connected to a first end of the heating coil; and
a second conductive pin, connected to a second end of the heating coil and penetrating the heating coil from the second end to the first end.
